(19) United States
(12) Patent Application Publication
(10) Pub. No.: US 2009/0267828 A1
(43) Pub. Date: Oct. 29, 2009

(54) GPS Signal Receiving Apparatus

(75) Inventors: Koichi Kobayashi, Tachikawa-shi (JP); Toru Sawada, Kunitachi-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/324,648

(22) Filed: Nov. 26, 2008

(30) Foreign Application Priority Data
Apr. 28, 2008 (JP) 2008-117785

(51) Int. Cl. G01S 1/00

(52) U.S. Cl. 342/357.06

(57) ABSTRACT

According to one embodiment, a GPS signal receiving apparatus comprises a receiving module configured to receive a GPS signal from a GPS satellite, an inclination detecting module configured to detect an inclination angle of the GPS signal receiving apparatus, a determining module configured to determine whether or not the receiving module receives a sufficient GPS signal to measure a position of the GPS signal receiving apparatus, and a notifying module configured to notify a user to change the inclination angle of the GPS signal receiving apparatus in accordance with the inclination angle detected by the inclination detecting module when the determining module determines that the sufficient GPS signal is not received.

### CROSS-REFERENCE TO RELATED APPLICATIONS

This application is based upon and claims the benefit of priority from Japanese Patent Application No. 2008-117785, filed Apr. 28, 2008, the entire contents of which are incorporated herein by reference.

### BACKGROUND

1. Field

One embodiment of the invention relates to a GPS signal receiving apparatus.

2. Description of the Related Art

There has heretofore been a car navigation system whereby the current position of a car or a route to a destination can be indicated using a global positioning system (GPS). Recently, the GPS system has come into use even in a portable terminal device such as a personal navigation device (PND) which is small-sized and portable. In the portable terminal device, if a user holds the device in a tilted state, the directional range of an antenna may change, or radio waves may be absorbed by the hand of the user which covers a receiving antenna, resulting in decreased performance of signal reception.

Jpn. Pat. Appln. KOKAI Publication No. 9-274075 describes a hand-held GPS receiver. This GPS receiver calculates an angle and a direction of a receiving surface of a flat aerial wire (receiving antenna), which is capable of receiving GPS signals from the greatest number of GPS satellites, and sends the calculation result to a display unit on which the calculation result is displayed. A package of the hand-held GPS receiver and the flat aerial wire are rotatably connected together by a direction-variable connector, and the user adjusts the direction of the receiving surface of the flat aerial wire referring to the display on the display unit.

Jpn. Pat. Appln. KOKAI Publication No. 2005-303856 describes a portable terminal device in which an antenna to be used is changed in accordance with change of a display direction of a display device so that an antenna with good reception performance can be selected. In this portable terminal device, a first antenna is used when the display direction is vertical, and a second antenna is used when the display direction is horizontal.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of a portable navigation device (PND) equipped with a GPS signal receiving apparatus according to an embodiment of the present invention;

FIG. 2 is an exemplary view showing an example of appearance of the portable navigation device;

FIG. 3 is an exemplary flowchart showing inclination correcting processing according to an embodiment;

FIG. 4 is an exemplary view showing an example of a navigation screen displayed during execution of a navigation application;

FIG. 5 is an exemplary view showing an example of a pop-up window displayed in the navigation screen;

FIG. 6 is an exemplary view showing schematically a situation where an electrically active antenna element is directed to the zenith and can receive GPS signals from four GPS satellites;

FIG. 7 is an exemplary view showing schematically a situation where the navigation device inclines and acquirable GPS satellites changes;

FIG. 8 is an exemplary flowchart showing directional range adjusting processing according to an embodiment;

FIG. 9 is an exemplary view for explaining an example of a directional range adjustment;

FIG. 10 is an exemplary flowchart showing antenna element selecting processing according to an embodiment;

FIG. 11 is an exemplary view showing an example of how a main body of the navigation device is held; and

FIG. 12 is an exemplary view showing another example of how the main body of the navigation device is held.

### DETAILED DESCRIPTION

Various embodiments according to the invention will be described herein after with reference to the accompanying drawings. In general, according to one embodiment of invention, a GPS signal receiving apparatus comprises a receiving module configured to receive a GPS signal from a GPS satellite, an inclination detecting module configured to detect an inclination angle of the GPS signal receiving apparatus, a determining module configured to determine whether or not the receiving module receives a sufficient GPS signal to measure a position of the GPS signal receiving apparatus, and a notifying module configured to notify a user to change the inclination angle of the GPS signal receiving apparatus in accordance with the inclination angle detected by the inclination detecting module when the determining module determines that the sufficient GPS signal is not received.

Hereinafter, an embodiment of a GPS signal receiving apparatus according to the present invention will be described with reference to the drawings.

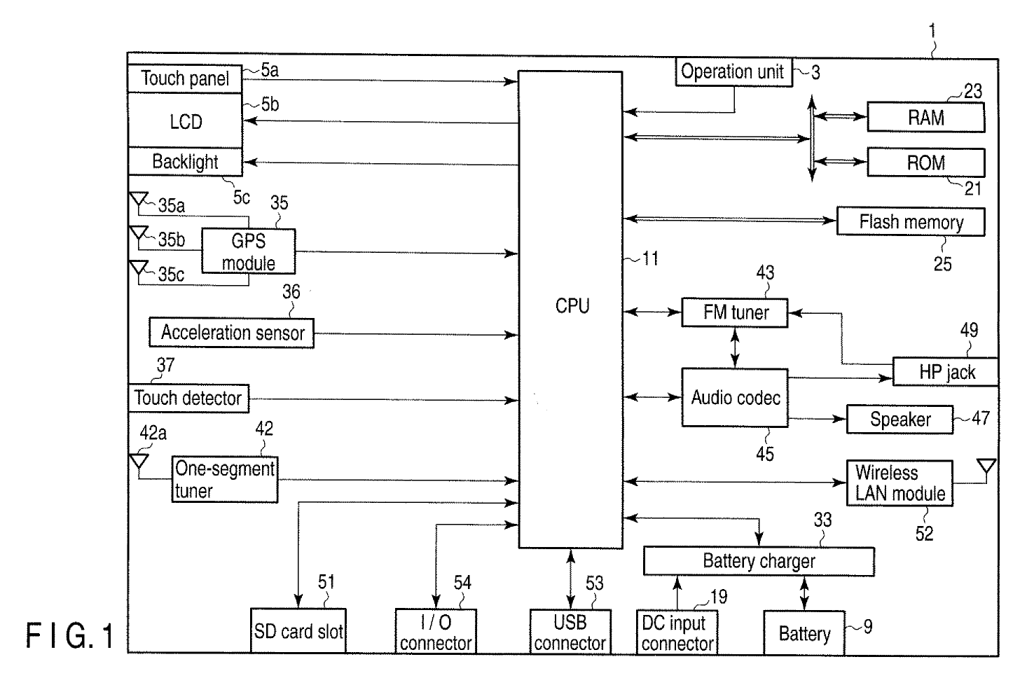

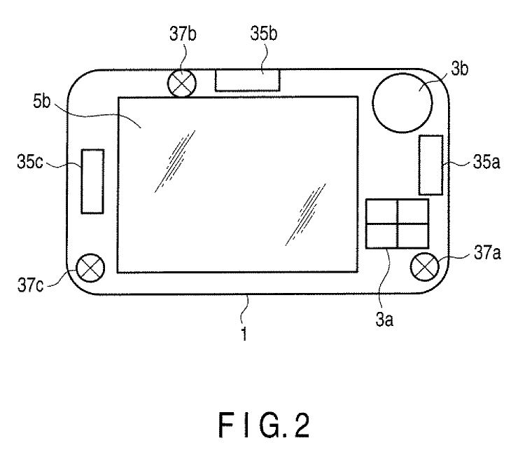

FIG. 1 is an exemplary block diagram showing a configuration of a portable navigation device (PND) 1 equipped with a GPS signal receiving apparatus according to an embodiment of the present invention. FIG. 2 is an exemplary view showing an example of appearance of the portable navigation device 1.

The portable navigation device 1 includes a CPU 11 which is a main control unit. The CPU 11 controls operation of each unit of the navigation device 1. Each unit of the navigation device 1 is connected to the CPU 11 via a bus.

Storage devices such as a ROM 21, a RAM 23 and a flash memory 25 are connected to the CPU 11. The ROM 21 prestores program data to be executed by the CPU 11 for controlling operations of the navigation device 1. The RAM 23 is used by the CPU 11 as a work memory. The RAM 23 temporarily stores control information corresponding to a control signal and a given amount of data read from the flash memory 25. The flash memory 25 stores various kinds of data, for example, image data, such as map information, and audio data. A hard disk drive (HDD) or others may be built in the navigation device 1 instead of the flash memory 25. Moreover, the flash memory 25 may be detachable from the navigation device 1.

An operation unit 3 includes, for example, operation buttons 3a and 3b, as shown in FIG. 2. A user can input an operation instruction and a selection instruction by operating the operation unit 3. A control signal corresponding to the operation of the operation unit 3 which is made by the user is sent to the CPU 11.

A liquid crystal display (LCD) 5b includes a backlight 5c, and displays image data such as map information and character information. A touch panel 5a is integrally attached onto the LCD 5b. The user can select coordinates and input a figure by touching the touch panel 5a with a finger or a pen. A control signal corresponding to the operation by the user is sent to the CPU 11.

A battery (internal battery) 9 is used as a power source when the navigation device 1 is portably carried on. A battery charger (charge unit) 33 is connected to the battery 9. Further, an external DC power source is connected to a DC input connector 19. Power for driving the navigation device 1 is supplied from the outside via the DC input connector 19 or from the charged battery 9. The battery charger 33 may be built in the navigation device 1. Alternatively, the battery 9 may be detached from the navigation device 1 and charged separately from the navigation device 1.

Headphones or earphones, which are not shown, can be attached to a headphone (HP) jack 49. Moreover, a headphone antenna in which a headphone is integrated with an FM antenna may be attached to the HP jack 49. Alternatively, an earphone antenna in which an earphone is integrated with an FM antenna may be attached to the HP jack 49. An FM (frequency modulation) tuner 43 tunes received FM broadcast. An audio codec 45 converts the tuned FM broadcast or music data stored in the flash memory 25 or the ROM 21 into signals which can be output, and the converted signals are output from a speaker 47 or the HP jack 49.

Also connected to the CPU 11 are an SD (secure digital) card slot 51, a wireless local area network (LAN) module 52, a universal serial bus (USS) connector 53 and an input/output (I/O) connector 54.

An external medium (SD card) can be inserted into the card slot 51. The CPU 11 can store data into the SD card via the slot 51. It is also possible to read and reproduce data stored in the SD card. The external medium is not limited to the SD card, and a storage device such as a memory stick may be externally attached to the navigation device 1.

The navigation device 1 can be connected to an external device using the wireless LAN module 52 and perform data communication with the external device. Various kinds of data are supplied from the external device to the navigation device 1 via the wireless LAN module 52. Further, data stored in the flash memory 25 can be supplied to the external device via the wireless LAN module 52. The navigation device 1 can wirelessly communicate with the external device such as a server computer or a personal computer via the wireless LAN module 52. The wireless LAN module 52 is also used for connection to a network such as the Internet. The navigation device 1 can download or upload data via the network. The data downloaded via the network is stored in the flash memory 25 or the SD card.

The navigation device 1 can be connected to an external device via the USB connector 53 and can exchange data with the external device. Various kinds of data are supplied to the navigation device 1 from the external device such as a personal computer (PC) via the USB connector 53. Data stored in the flash memory 25 may be supplied to the external device via the USB connector 53.

Furthermore, communication with the external device may be performed via the I/O connector 54. For example, an external personal computer or an input device (e.g., a keyboard or mouse) other than the touch panel can be connected via the I/O connector 54. The user can input an operation instruction and a selection instruction by operating the personal computer or the input device. A control signal corresponding to the operation by the user is sent to the CPU 11 from the I/O connector 54. Moreover, data reproduced by the CPU 11 may be displayed on an external display device connected via the I/O connector 54.

A one-segment tuner 42 is used to receive terrestrial digital broadcasting for mobile objects (one-segment broadcasting). A digital broadcast signal received by an antenna 42a is tuned and demodulated by the one-segment tuner 42. The CPU 11 subjects the received digital broadcast signal to predetermined decoding processing and converts the signal into a reproducible format.

A GPS module 35 is build in the navigation device 1, and includes antenna elements 35a, 35b and 35c for receiving a GPS signal from a GPS satellite. The antenna element 35a, 35b, 35c includes a film antenna by way of example. Generally, one of the antenna elements is electrically activated and used to receive the GPS signal. The antenna element to be electrically activated may be set by default or may be selected and set in accordance with an instruction given by the user. Although three antenna elements are shown in FIGS. 1 and 2, the number of antenna elements is not limited to this, and four or more antenna elements may be built in the navigation device 1. When the electrically active antenna element can receive signals from three GPS satellites, a two-dimensional position of the navigation device 1 (latitude and longitude) can be measured. When signals from four GPS satellites can be received, a three-dimensional position (latitude, longitude and altitude) can be measured. If GPS signals from three or four satellites are received by one of the antenna elements, a distance from each satellite is calculated and the current position of the navigation device 1 is measured. For favorable reception of a GPS signal, it is preferable that the navigation device 1 is held so that the active antenna element is directed to the zenith.

An acceleration sensor 36 is used to detect an inclination (inclination angle) of the main body of the navigation device 1. In the present embodiment, processing to assure a preferable reception state for a GPS signal is performed depending on the inclination of the navigation device 1 detected by the acceleration sensor 36.

A touch detector 37 includes touch sensors 37a, 37b and 37c, and detects a place on the navigation device 1 touched by a body part (hand or arm) of the user. If an antenna element is in the vicinity of the touch sensor detecting the touch with the body, the antenna element is highly likely to be covered with the body. The human body easily absorbs radio waves. Therefore, when the electrically active antenna element is covered with the body, radio waves from a GPS satellite are absorbed by the body and reception state of the radio waves tends to deteriorate. In the present embodiment, the touch sensors 37a, 37b and 37c are disposed in the vicinity of the antenna elements 35a, 35b and 35c, respectively, and whether or not a body part covers any antenna element is detected.

In FIG. 2, three touch sensors and three antenna elements are shown. This arrangement is provided with the intention that, regardless of whether the user holds the navigation device 1 by a long side or short side thereof, at least one antenna element remains not prevented from receiving a signal by the body of the user. However, the number and arrangement of the touch sensors are not limited to the above. A proper arrangement can be prepared depending on the shape and size of the navigation device 1.

The portable navigation device 1 is used being portably carried on by the user. Thus, the navigation device 1 tends to be used in an inclined state. If the navigation device 1 is inclined and the electrically active antenna element is directed off the zenith, sufficient signal intensity may not be obtained. Moreover, a signal from a GPS satellite at a low altitude is susceptible to a multi-path error. The multi-path error is caused by reception of radio waves from a GPS satellite after reflected by buildings and trees in the vicinity of the ground or by the surface of the ground. Therefore, particularly when the portable navigation device 1 is used in a city where there are many tall buildings, a reception state of the GPS signals deteriorates due to the multi-path and the like.

Described below is processing for improving the reception state of a GPS signal in the portable navigation device I having the configuration above.

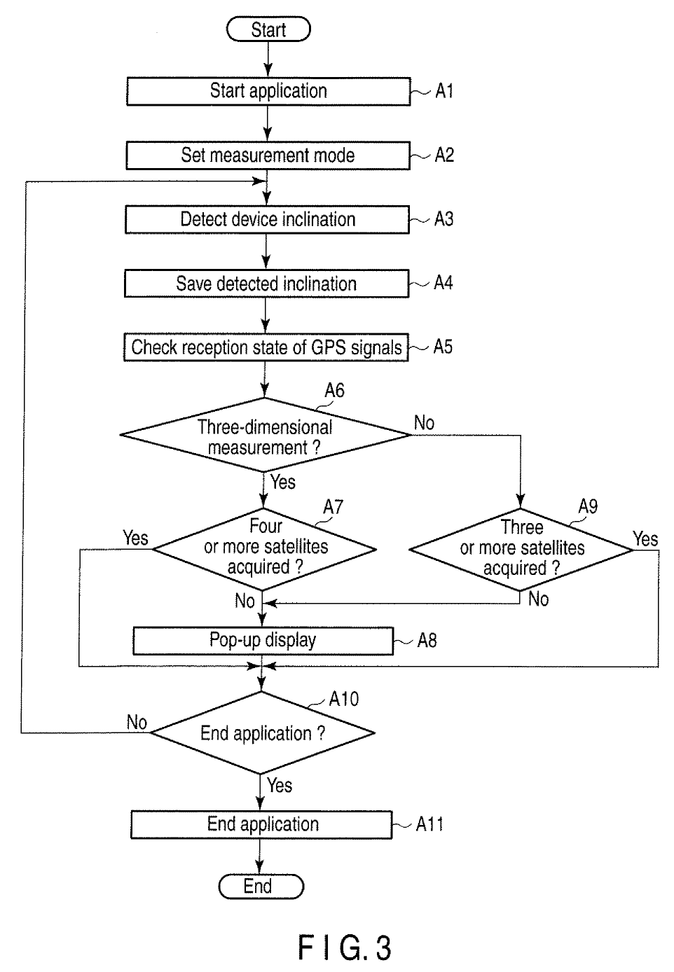

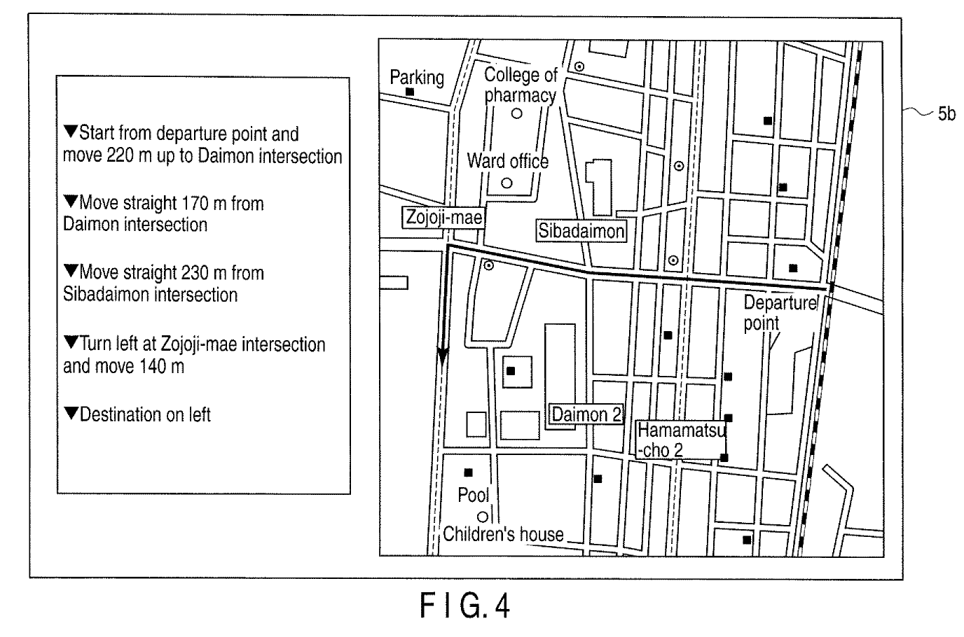

FIG. 3 is an exemplary flowchart of inclination correcting processing according to the present embodiment. This inclination correcting processing is performed during operation of an application which utilizes the GPS system. FIG. 4 is an exemplary view showing an example of a navigation screen displayed on the LCD 5b during execution of a navigation application which uses the GPS system to show the way to a destination. In the example shown in FIG. 4, a current position of the navigation device 1 measured on the basis of GPS signals is plotted on a map, and the way to the destination is displayed. When the user inclines the navigation device 1 during the execution of such an application which utilizes the GPS system, the electrically active antenna element is directed off the zenith and the reception state deteriorates. Otherwise, if there is, for example, a tall building around, the reception state of a GPS signal may deteriorate due to the blockage by the building, or the multi-path error may be caused. The inclination correcting processing shown in the flowchart of FIG. 3 is processing for notifying the user of the deteriorated reception state to correct the inclination.

When an application program is started (block A1), the CPU 11 sets either a two-dimensional measurement mode for measuring current latitude and longitude of the navigation device 1 or a three-dimensional measurement mode for measuring altitude in addition to latitude and longitude (block A2). In block A2, the measurement mode may be set in accordance with setting of the application in operation; for example, the two-dimensional measurement mode may be set when a planar map is displayed in the navigation screen, or the three-dimensional measurement mode may be set when a topographical map is displayed. Alternatively, the user may be prompted to select a measurement mode. Furthermore, such configuration is also possible that previous settings are stored in advance, and the stored settings are read and set.

Then, the inclination angle of the navigation device 1 is detected by the acceleration sensor 36 (block A3), and the detected inclination angle is saved in a predetermined storage area in the RAM 23 (block A4).

The CPU 11 checks a GPS signal reception state of an electrically active antenna element based on position measurement data from the GPS module 35 (block A5). To be specific, a check is made, for example, on the incidence of errors in the received data and on whether or not signal intensity of the received signal is sufficient for GPS signal detection. As the electrically active antenna element, one of the antenna elements 35a to 35c in the GPS module 35 may be set by default, or one of the antenna elements may be previously selected by the user.

Then, the CPU 11 determines whether or not the measurement mode set in block A2 is the three-dimensional measurement mode (block A6). When it is determined that the three-dimensional measurement mode is set (Yes in block A6), further determination is made on whether or not it is possible to acquire four or more GPS satellites and to calculate three-dimensional data including latitude, longitude and altitude of the navigation device 1 (block A7). This determination is made based on the result of checking executed in block A5.

When merely three or less GPS satellites are acquired by the active antenna element and three-dimensional position measurement data can not be obtained (No in block A7), pop-up display is shown to prompt the user to correct the inclination of the navigation device 1 so that the antenna element may be directed to the zenith (block A8). That is, it is displayed based on the inclination saved in block A4 how to hold the navigation device 1 to improve the reception state.

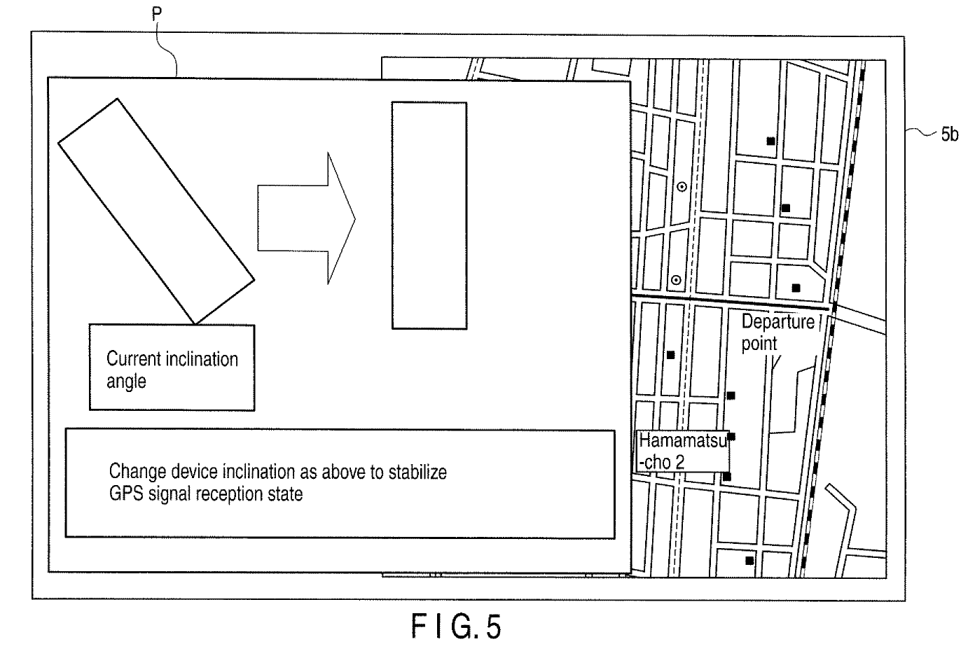

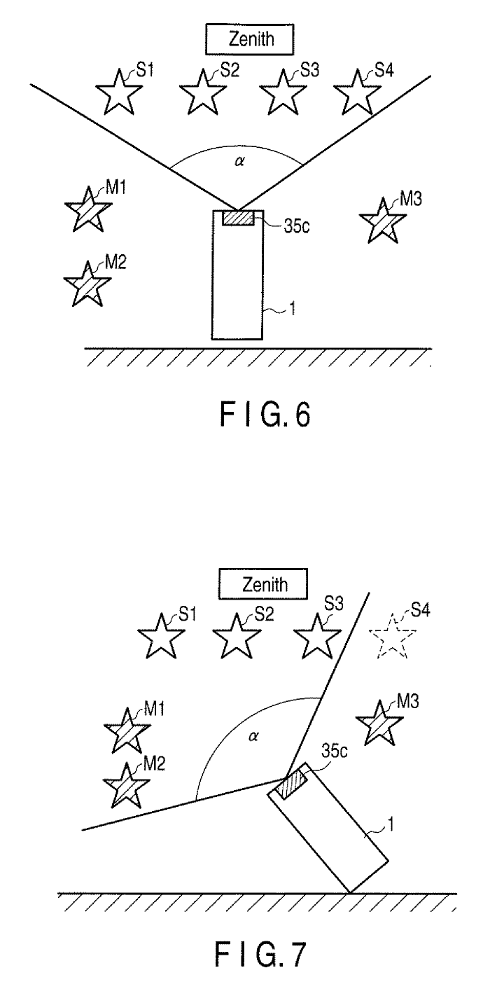

FIG. 5 is an exemplary view showing an example of a pop-up window P displayed on the navigation screen. The pop-up window P shows and presents to the user the current inclination angle of the device and an optimum inclination angle of the device. Referring to the display in this pop-up window P, the user corrects the way of holding the device so that the inclination angle of the device may be a proper angle, thereby improving the reception state. For example, the user holds the navigation device 1 perpendicularly to the ground so that the active antenna element can be directed to the zenith (see FIG. 6). However, depending on the manner the antenna elements are positioned, the active antenna element may be directed to the zenith when being held inclined with respect to the ground.

On the other hand, when it is determined in block A6 that the two-dimensional measurement mode is set (No in block A6), further determination is made on whether or not it is possible to acquire three or more GPS satellites and to calculate two-dimensional data including latitude and longitude (block A9).

When merely two or less GPS satellites are acquired by the active antenna element and two-dimensional position measurement data can not be obtained (No in block A9), pop-up display is shown to prompt the user to correct the inclination of the navigation device 1 so that the antenna element can be directed to the zenith (block A8). In this case as well, the pop-up window P as shown in FIG. 5 is displayed, and an optimum inclination angle of the device is shown and presented to the user to improve the reception state of GPS signals.

Thereafter, the processing from block A3 is repeated until an instruction is issued to end the application (until the determination result becomes “Yes” in block A10). When an instruction is issued to end the application (Yes in block A10), the application in operation is ended (block A11).

As described above, according to the inclination correcting processing, even when the main body of the device is Inclined during the execution of the application which utilizes the GPS and the reception state of GPS a signal deteriorates, the user can be prompted to correct the Inclination. As the user changes the inclination of the device even temporarily in accordance with the pop-up display, the accuracy of position measurement is improved. Moreover, the current position to be displayed on the map becomes accurate, and accurate navigation can be achieved.

FIG. 6 is an exemplary view showing schematically a situation where the electrically active antenna element (antenna element 35c in this example) is directed to the zenith and can receive GPS signals from four GPS satellites S1 to S4. That is, the GPS satellites S1 to S4 are situated within a directional range α of the antenna element 35c, and the antenna element 35c acquires the GPS satellites S1 to S4. As described above, when GPS signals from four or more GPS satellites are receivable, three-dimensional position measurement can be performed. However, as shown in FIG. 7, when the navigation device 1 is inclined, the GPS satellite S4 is out of the directional range α, and GPS satellites M1 and M2 at low altitudes enter the directional range α instead.

Signals from GPS satellites at low altitudes are susceptible to a multi-path error. As shown in FIG. 7, although four or more GPS satellites are within the directional range α of the antenna element 35c, when these GPS satellites include satellites M1 and M2, which easily cause errors, the errors may yield an inaccurate measurement result.

Processing for reducing such errors will be described below.

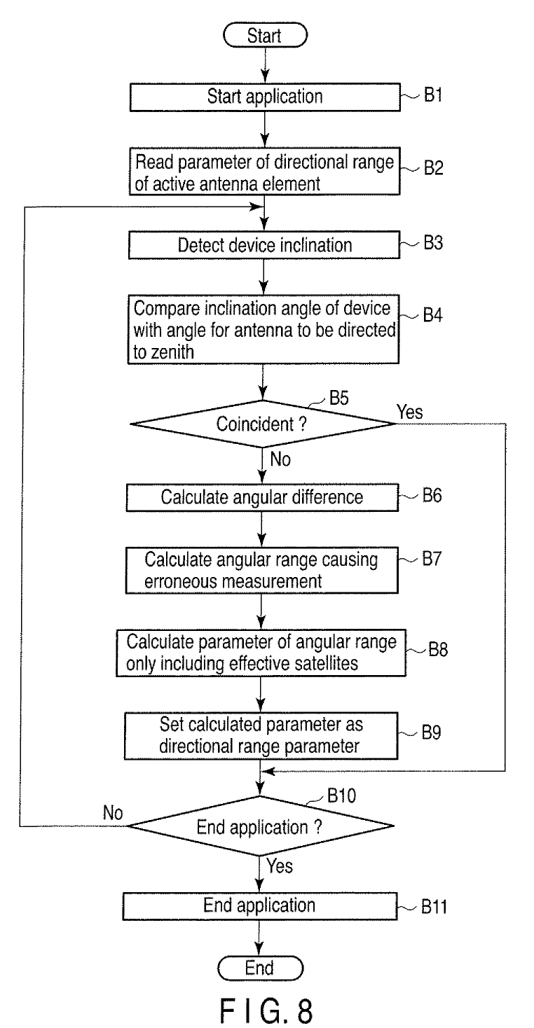

FIG. 8 is an exemplary flowchart showing directional range adjusting processing according to the present embodiment. This directional range adjusting processing is executed during operation of an application which utilizes the GPS system.

When an application program which utilizes the GPS system such as a navigation application is started (block B1), the CPU 11 reads from the memory a parameter or parameters indicating the directional range α of the electrically active antenna element (block B2). As the electrically active antenna element, one of the antenna elements 35a to 35c may be set by default, or one of the antenna elements may be previously selected by the user. Parameters indicating directional ranges of the antenna elements are prestored in the ROM 21, for example. The parameters may be in any form as long as the parameters can represent the directional ranges of the antenna elements. For example, elevation angles of both ends of a directional range from the ground are used as such parameters.

Then, the inclination angle of the navigation device 1 is detected by the acceleration sensor 36 (block B3), and the detected inclination angle is compared with an inclination angle of the navigation device 1 at which the active antenna element can be directed to the zenith (block B4). In the example in FIG. 6, the antenna element 35c is directed to the zenith when the navigation device 1 is held perpendicularly to the ground. However, depending on a manner the antenna elements are placed, the effective antenna element may be directed to the zenith when being held inclined with respect to the ground. The inclination angle of the navigation device 1 for directing the effective antenna element to the zenith is previously written in, for example, the ROM 21 for each antenna element.

The CPU 11 determines whether or not the detected inclination angle of the navigation device 1 is coincident with the inclination angle for directing the active antenna element to the zenith (block B5).

When both angles are coincident with each other, adjustment of the directional range is not necessary and the processing from block B3 is repeated until an instruction is issued to end the application (until the determination result becomes “Yes” in block B10). When an instruction is issued to end the application (Yes in block B10), the application in operation is ended (block B11).

On the other hand, when it is determined that the inclination angles are not coincident with each other (No in block B5), difference (disparity) between the inclination angle of the navigation device 1 and the Inclination angle for directing the effective antenna element to the zenith is calculated (block B6).

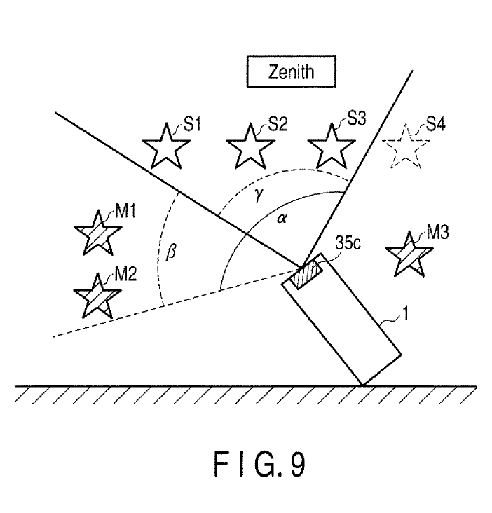

Then, on the basis of the result of the calculation, the CPU 11 calculates an angular range including the GPS satellite likely to cause erroneous position measurement (block B7). For example, as shown in FIG. 9, an angular range β including the GPS satellites M1 and M2 at low altitudes is calculated. The angular range β may be determined to coincide with the difference of angles calculated in block B6. Alternatively, altitudes of the GPS satellites may be figured out based on signals from the respective GPS satellites, and such an angular range that does not include a GPS satellite having altitude equal to or lower than a predetermined threshold value and assures reception of signals from three or more GPS satellites may be found in accordance with the difference of angles calculated in block B6 and determined to be the angular range β. In addition, any other method may be used as long as an angular range including a GPS satellite causing the multi-path error or other errors can be determined.

Then, the CPU 11 calculates an angular range including merely GPS satellites effective in position measurement, and a parameter (or parameters) representing the angular range is calculated (block B8). For example, in the example shown in FIG. 9, exclusion of the angular range β including the satellite which may cause an error from the directional range α of the antenna element 35c results in an angular range γ, the angular range γ is considered to include the effective GPS satellites alone, and a parameter (or parameters) representing the angular range γ is calculated. Then, the calculated parameter is newly set as a directional range parameter of the active antenna element (block B9).

Subsequently, the processing from block B3 is repeated until an instruction is issued to end the application (until the determination in block B10 result in “Yes”). When an instruction is issued to end the application (Yes in block B10), the application in operation using the GPS is ended (block B11).

As described above, according to the directional range adjusting processing, even when the main body of the navigation device 1 is inclined, a parameter of the directional range of an antenna can be set so that signals from effective GPS satellites alone can be received and a signal from a GPS satellite which may cause an error is not received. The angular range including the GPS satellite which may cause an error is calculated based on an inclination angle of the device detected by the acceleration sensor. Thus, it is possible to automatically set an optimum effective directional range of the antenna element in accordance with the inclination angle of the device, and highly accurate measurement is constantly provided.

The processes described above improve reception state of an electrically activated antenna element out of a plurality of antenna elements. However, a satisfactory reception state may not be assured when a body part of the user covers the electrically active antenna element and radio waves from a GPS satellite are thus blocked. Explained below is processing for selecting an antenna element which brings a more satisfactory reception state out of a plurality of antenna elements.

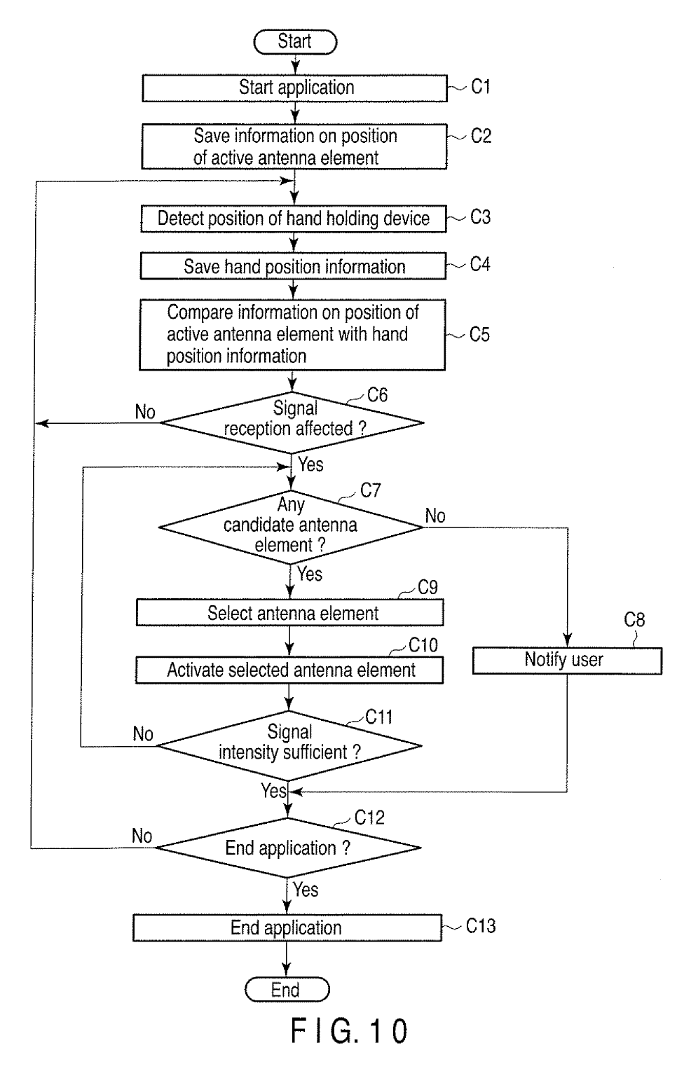

FIG. 10 is an exemplary flowchart of the antenna element selecting processing according to the present embodiment. The antenna element selecting processing is executed during operation of an application which utilizes the GPS system.

When an application program which utilizes the GPS system such as a navigation application is started (block C1), the CPU 11 saves information on a position (position information) of an electrically active antenna element in, for example, the RAM 23 (block C2). The antenna element which is electrically active at the time of the processing of block C2 is one of the antenna elements 35a to 35c selected by default or selected previously by the user. Moreover, the position information to be stored in block C2 is information which indicates where the electrically active antenna element is located on the navigation device 1.

Then, on the basis of touch-detection states of the touch sensors 37a to 37c, the CPU 11 detects which position on the navigation device 1 the body (a part of the human body such as a hand or arm) of the holder (user) of the navigation device 1 is touching (block C3), and the CPU 11 saves position information on the detected touched place (block C4).

The CPU 11 compares the position information on the touched place with the position information on the active antenna element (block C5). Then, it is determined whether or not the touch sensor in the vicinity of the active antenna element detects touch with the body and GPS signal reception by the active antenna element is affected (block C6).

When the touch sensor in the vicinity of the active antenna element does not detect the touch with the body, GPS signal reception is not affected (No in block C6); therefore, the CPU 11 repeats the processing from block C3.

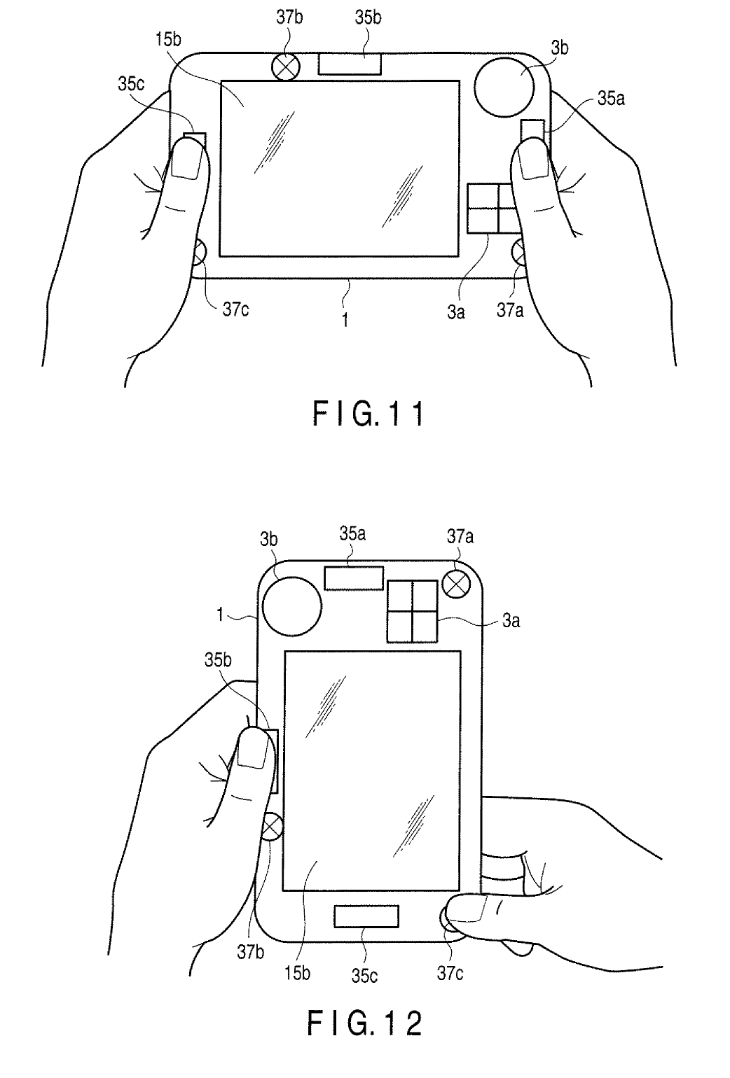

On the other hand, as shown in FIG. 11, for example, when the user holds the navigation device 1 by the short sides thereof and the left and right hands of the user are covering the touch sensors 37c and 37a, respectively, the left and right hands of the user are also in touch with the antenna elements 35c and 35a which are in the vicinity of the touch sensors 37c and 37a. When either of the antenna elements 35a and 35c is electrically active, the signal reception is affected and the determination result in block C6 becomes “Yes”.

In addition, as shown in FIG. 12, when the user holds the navigation device 1 by the long sides thereof and the left and right hands of the user are covering the touch sensors 37b and 37c, respectively, the left hand of the user is also in touch with the antenna element 35b in the vicinity of the touch sensor 37b. Moreover, as the antenna element 35c, which is in the vicinity of the touch sensor 37c, is close to the body of the user and radio waves will be easily absorbed, the antenna element 35c is considered not to be suitable for signal reception. Therefore, when either antenna element 35b or 35c is electrically active, the signal reception is affected and the determination result in block C6 becomes “Yes”.

When the touch sensor in the vicinity of the active antenna element detects touch with the body (Yes in block C6), it is considered that reception of a GPS signal is affected. The CPU 11 determines whether or not there is any candidate antenna element other than the currently active antenna element in the vicinity of a touch sensor not detecting touch with the body (block C7). When there is no candidate antenna element (No in block C7), the user is prompted to take a hand off a touch sensor (block C8), for example, by a message displayed on the LCD 5b.

On the other hand, when there is one or more antenna elements in the vicinity of a touch sensor not detecting touch with the body (Yes in block C7), one of such antenna elements is selected and determined to be a candidate antenna element (block C9) and the candidate antenna element is electrically activated (block C10). When a plurality of antenna elements can be the candidate antenna element, the candidate antenna element is selected on the basis of the inclination angle of the navigation device 1 detected by the acceleration sensor 36. For example, the highest (closest to the zenith) antenna element is selected based on the inclination angle of the navigation device 1, and this antenna element is determined to be the candidate antenna element.

After the selected candidate antenna element is electrically activated, the CPU 11 checks GPS signal reception state of the candidate antenna element and determines whether or not sufficient signal intensity is obtained (block C11).

When it is determined that sufficient signal intensity is not obtained (No in block C11), the processing from block C7 is repeated, and another antenna element which is not touched with the body is selected. On the other hand, when it is determined that sufficient signal intensity is obtained (Yes in block C11), whether or not to end the application is determined (block C12).

Thus, the processing from block C3 is repeated until an instruction is issued to end the application (until determination result in block C12 becomes “Yes”). When an instruction is issued to end the application (Yes in block C12), the application in operation is ended (block C13).

As described above, according to the antenna element selecting processing, a suitable antenna element can be selected based on how the user is holding the navigation device 1 (based on whether the user is holding with the right hand, the left hand or both hands, or based on whether the user is holding the device by a long side or short side thereof). Therefore, it is possible to improve GPS signal reception state and to enhance position measurement accuracy.

In the processing in block C10 described above, when a plurality of antenna elements can be a candidate antenna element, the candidate antenna element is decided on the basis of the inclination angle of the navigation device 1 that is detected by the acceleration sensor 36. However, other selection methods may be used; for example, the priority order of the plurality of antenna elements may be previously determined, and an antenna element may be selected in the order of priority.

As described above, according to the inclination correcting processing of the present embodiment (FIG. 3), when the main body of the device is held in an inclined state and reception state of a GPS signal thus deteriorates, the user can be prompted to correct the inclination by pop-up display. Further, according to the directional range adjusting processing of the present embodiment (FIG. 8), even when the main body of the device is inclined, a directional range of an active antenna can be adjusted in accordance with the inclination of the device, and reception of a signal from a GPS satellite likely to cause an error is prevented so that signals from effective GPS satellites alone can be received. Still further, according to the antenna element selecting processing of the present embodiment (FIG. 10), a suitable antenna element can be selected from among a plurality of antenna elements depending on how the user is holding the main body of the device. Such processing enables a highly accurate position measurement.

In addition, although it is described that the touch detector 37 includes the touch sensors 37a to 37c in the above description, a similar function can also be achieved when an optical sensor is used instead of the touch sensor. The optical sensor can detect brightness (illuminance) of a place on the device where the human hand or arm touches and brightness around the device. Otherwise, a body temperature sensor which can detect a temperature of a human body may be used, or a pressure sensor which can detect pressure caused by gripping or pressing the device may be used.

Furthermore, although the acceleration sensor 36 is used to detect the inclination angle of the navigation device 1, a gyro-sensor or geomagnetic sensor may be used instead.

Still further, radio waves are invisible to human eyes; however, the directional range adjusting processing shown in FIG. 8 makes it possible to visually recognize how much effects of the multi-path error are produced and whether or not the multi-path error has an adverse effect on the accuracy of a GPS signal.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The various modules of the systems described herein can be implemented as software applications, hardware and/or software modules, or components on one or more computers, such as servers. While the various modules are illustrated separately, they may share some or all of the same underlying logic or code.

What is claimed is:

1. A GPS signal receiving apparatus comprising:
a receiving module configured to receive a GPS signal from a GPS satellite;
an inclination detecting module configured to detect an inclination angle of the GPS signal receiving apparatus;
a determining module configured to determine whether or not the receiving module receives a sufficient GPS signal to measure a position of the GPS signal receiving apparatus; and
a notifying module configured to notify a user to change the inclination angle of the GPS signal receiving apparatus in accordance with the inclination angle detected by the inclination detecting module when the determining module determines that the sufficient GPS signal is not received.

2. The GPS signal receiving apparatus of claim 1, wherein the notifying module displays an optimum inclination angle to receive the sufficient GPS signal and notifies the user to hold the GPS signal receiving apparatus at the optimum inclination angle.

3. The GPS signal receiving apparatus of claim 1, wherein the notifying module displays in a pop-up manner on a display module the inclination angle detected by the inclination detecting module and an optimum inclination angle to receive the sufficient GPS signal.

4. The GPS signal receiving apparatus of claim 1, wherein the inclination detecting module comprises an acceleration sensor which detects the inclination angle of the GPS signal receiving apparatus.

5. The GPS signal receiving apparatus of claim 1, wherein the receiving module includes antenna elements, and
the GPS signal receiving apparatus further comprising:
a touch detecting module configured to detect touch with a human body on the GPS signal receiving apparatus; and
an antenna activating module configured to activate, among the antenna elements, an antenna element on which no touch with the human body is detected by the touch detecting module.

6. The GPS signal receiving apparatus of claim 5, wherein the antenna activating module selects an antenna element to be activated based on the inclination angle detected by the inclination detecting module.

7. The GPS signal receiving apparatus of claim 5, wherein the touch detecting module comprises a touch sensor which detects touch with the human body.

8. The GPS signal receiving apparatus of claim 7, wherein the antenna activating module activates an antenna element in a vicinity of a touch sensor not detecting touch with the human body.

9. A GPS signal receiving apparatus comprising:
a receiving module including an antenna element and configured to receive a GPS signal from a GPS satellite;
a calculating module configured to calculate an angular range within a directional range of the antenna element which results in reception of a GPS signal causing an error; and
an adjusting module configured to adjust the directional range of the antenna element such that the directional range does not include the angular range calculated by the calculating module.

10. The GPS signal receiving apparatus of claim 9, further comprising an inclination detecting module configured to detect an inclination angle of the GPS signal receiving apparatus, and
wherein the calculating module calculates the angular range which results in reception of a GPS signal causing an error in accordance with the inclination angle detected by the inclination detecting module.

11. The GPS signal receiving apparatus of claim 10, wherein
the calculating module calculates an angular difference between the inclination angle detected by the inclination detecting module and an inclination angle of the GPS signal receiving apparatus for the antenna element to direct zenith, and
the adjusting module eliminates the angular difference from the directional range of the antenna element.

12. The GPS signal receiving apparatus of claim 10, wherein the inclination detecting module comprises an acceleration sensor which detects the inclination angle of the GPS signal receiving apparatus.

13. The GPS signal receiving apparatus of claim 9, wherein the receiving module includes antenna elements, and
the GPS signal receiving apparatus further comprising:
a touch detecting module configured to detect touch with a human body on the GPS signal receiving apparatus; and
an antenna activating module configured to activate, among the antenna elements, an antenna element on which no touch with the human body is detected by the touch detecting module.

14. The GPS signal receiving apparatus of claim 13, further comprising an inclination detecting module configured to detect an inclination angle of the GPS signal receiving apparatus, and
wherein the antenna activating module selects an antenna element to be activated based on the inclination angle detected by the inclination detecting module.

15. The GPS signal receiving apparatus of claim 13, wherein the touch detecting module comprises a touch sensor which detects touch with the human body.

16. The GPS signal receiving apparatus of claim 15, wherein the antenna activating module activates an antenna element in a vicinity of a touch sensor not detecting touch with the human body.
